(19) United States
(12) Patent Application Publication
(10) Pub. No.: US 2020/0247703 A1
(43) Pub. Date: Aug. 6, 2020

(54) DROPPING NOZZLE AND MOLDING APPARATUS

(71) Applicant: Konica Minolta Inc., Tokyo (JP)

(72) Inventors: YASUO OOMORI, Tokyo (JP); CHIAKI MACHIDA, Tokyo (JP); TAKAYUKI KAMIKURA, Tokyo (JP)

(21) Appl. No.: 16/745,177

(22) Filed: Jan. 16, 2020

(30) Foreign Application Priority Data
Feb. 1, 2019 (JP) 2019-016962

(51) Int. Cl. C03B 7/088; C03B 11/00

(52) U.S. Cl. CPC C03B 7/088; C03B 11/00

(57) ABSTRACT

A dropping nozzle includes: a flow passage part that includes a flow passage that molten glass passes through; and an opening part that includes an opening that communicates with the flow passage, the opening part dropping the molten glass as a glass drop, wherein the opening includes a plurality of inclined parts in which adjacent inner inclination angles are different from each other in a section parallel to a center axis of the flow passage part, and from among the plurality of inclined parts, a first inclined part that is closest to the flow passage part has an inner inclination angle that is smaller than an inner inclination angle of a second inclined part that is farthest from the flow passage part.

The entire disclosure of Japanese patent Application No. 2019-016962, filed on Feb. 1, 2019, is incorporated herein by reference in its entirety.

### BACKGROUND

### Technological Field

The present invention relates to a dropping nozzle that forms a glass drop to be used to mold a glass molded body, and a molding apparatus that includes the dropping nozzle.

### Description of the Related Art

A method has been provided for dropping a glass drop by using a dropping nozzle when a molded lens or a gob (a glass gob) is manufactured. An example of a dropping nozzle that forms a glass drop is a dropping nozzle in which ruggedness is formed at part of or the entirety of a distal end of the nozzle and a bent part having an inner angle of 30° or more and 120° or less is included in part of a projection of the ruggedness (see JP 2010-235425 A). In addition, the thickness of the nozzle disclosed in JP 2010-235425 A ranges from 0.3 mm to 1.0 mm. In the nozzle disclosed in JP 2010-235425 A, wetting-up is suppressed when the weight of a glass drop is adjusted.

Another example of a dropping nozzle that forms a glass drop is a dropping nozzle that includes a cylindrical flow passage forming part that is internally provided with a flow passage that molten glass passes through, a reference surface that is located at a lower end of the flow passage forming part and is formed according to a desired weight of a glass drop, a cylindrical part that is provided on a lower side in a vertical direction of a height position of the reference surface (see JP 2013-43792 A). The nozzle disclosed in JP 2013-43792 A uses wetting-up to adjust the weight of the glass drop. Molten glass is accumulated in a part below the reference surface, and is dropped, so that a desired glass drop is obtained.

The dropping nozzle disclosed in JP 2010-235425 A has a problem in which processing is difficult due to a complicated shape of the distal end of the nozzle, and a problem in which glass comes into contact with a complicated structure of the distal end of the nozzle and drops, and this results in a low stability of weight.

In addition, the dropping nozzle disclosed in JP 2013-43792 A has a problem in which the processing of the reference surface on a side of the distal end of the nozzle and the cylindrical part is complicated, and a problem in which the quality of a molded body deteriorates due to a difference in temperature between glass in a wetting-up part and glass inside the nozzle.

### SUMMARY

The present invention has been made in view of the related art described above. It is an object of the present invention to provide a dropping nozzle that avoids wetting-up of molten glass and reduces a variation in weight of a glass drop.

It is also an object of the present invention to provide a molding apparatus that includes the dropping nozzle described above.

To achieve at least one of the abovementioned objects, according to an aspect of the present invention, a dropping nozzle reflecting one aspect of the present invention comprises: a flow passage part that includes a flow passage that molten glass passes through and an opening part that includes an opening that communicates with the flow passage the opening part dropping the molten glass as a glass drop, wherein the opening includes a plurality of inclined parts in which adjacent inner inclination angles are different from each other in a section parallel to a center axis of the flow passage part, and from among the plurality of inclined parts, a first inclined part that is closest to the flow passage part has an inner inclination angle that is smaller than an inner inclination angle of a second inclined part that is farthest from the flow passage part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a sectional view explaining a molding apparatus according to a first embodiment;

FIG. 2 is another sectional view explaining the molding apparatus according to the first embodiment;

FIG. 3 is an enlarged sectional view explaining a dropping nozzle in a mold illustrated in FIG. 2;

FIGS. 4A and 4B are diagrams explaining variations of the dropping nozzle illustrated in FIG. 3;

FIGS. 5A and 5B are conceptual diagrams explaining a flow of molten glass in the dropping nozzle;

FIGS. 6A to 6D are conceptual diagrams explaining a process of manufacturing a lens by using the molding apparatus illustrated in FIG. 1 and the like:

FIG. 7 is an enlarged sectional view explaining a dropping nozzle according to a second embodiment; and

FIG. 8 is an enlarged sectional view explaining a dropping nozzle according to a third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

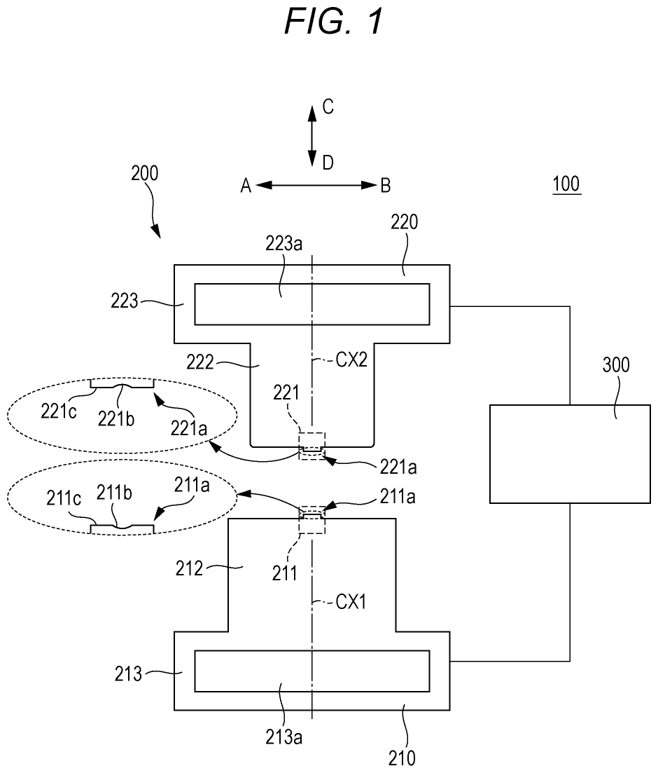

A dropping nozzle according to a first embodiment of the present invention and a molding apparatus including the dropping nozzle are described with reference to FIG. 1 and the like.

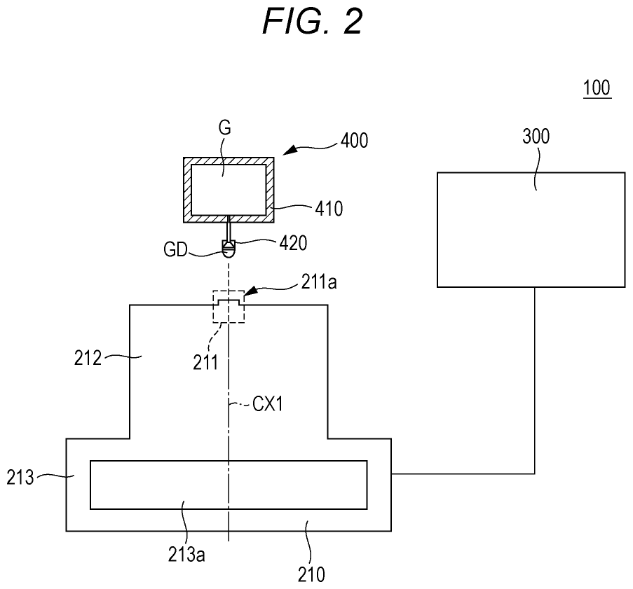

As illustrated in FIGS. 1 and 2, a molding apparatus 100 is an apparatus for pressure molding that melts glass serving as a raw material of a molded body and directly presses the glass. The molding apparatus 100 includes a mold 200, a control driving device 300, and a glass drop forming device 400.

As illustrated in FIG. 1, the mold 200 includes a first mold 210 and a second mold 220. In molding, the first mold 210 moves so as to face the second mold 220, and a mold closing operation is performed in such a way that both molds 210 and 220 abut onto each other.

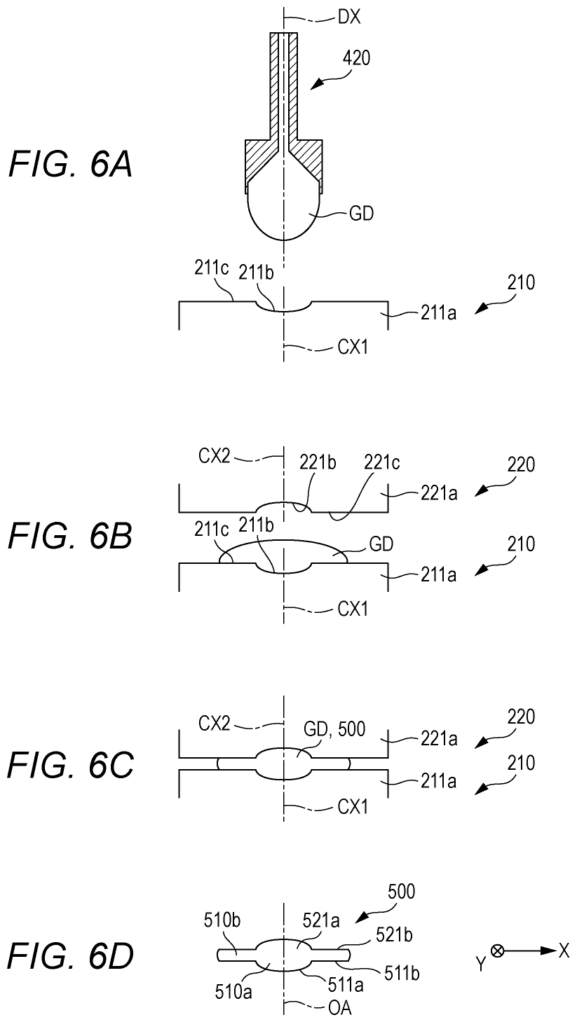

The first mold 210 includes a first mold body 211, a first support part 212, and a first heater 213. In the first mold 210, the first mold body 211 has a cylindrical shape, and includes a first transfer surface 211a. The first transfer surface 211a includes a first optical transfer surface 211b that forms a first optical surface 511a in a lens 500 described later (see FIG. 6D), and a first flange transfer surface 211c that forms a first flange surface 511b. A glass drop GD (see FIG. 6A) that has been formed by a dropping nozzle 420 provided in the glass drop forming device 400 is dropped on the first transfer surface 211a, but details are described later.

The first support part 212 is disposed between the first mold body 211 and the first heater 213, and supports the first mold body 211 from behind.

The first heater 213 is provided in a root of the first support part 212. The first heater 213 incorporates an electric heater 213a that moderately heats the first mold body 211.

The second mold 220 is described next. As illustrated in FIG. 1, the second mold 220 includes a second mold body 221, a second support part 222, and a second heater 223. In the second mold 220, the second mold body 221 has a cylindrical shape, and includes a second transfer surface 221a. The second transfer surface 221a includes a second optical transfer surface 221b that forms a second optical surface 521a in the lens 500 (see FIG. 6D), and a second flange transfer surface 221c that forms a second flange surface 521b. The second optical transfer surface 221b is located so as to correspond to the first optical transfer surface 211b.

The second support part 222 is disposed between the second mold body 221 and the second heater 223, and supports the second mold body 221 from behind.

The second heater 223 is provided in a root of the second support part 222. The second heater 223 incorporates an electric heater 223a that moderately heats the second mold body 221.

The first mold 210 and the second mold 220 has an appropriate positional relationship, for example, in such a way that the first transfer surface 211a of the first mold 210 and the second transfer surface 221a of the second mold 220 are coaxially disposed in pressure molding and the first transfer surface 211a and the second transfer surface 221a are spaced apart from each other by a predetermined interval in pressing and in cooling.

The control driving device 300 causes the mold 200 to perform movement, an opening/closing operation, or another operation in the manufacture of the lens 500 serving as a molded body. Specifically, in order to mold the lens 500 by using the mold 200, the control driving device 300 controls power feeding to the electric heaters 213a and 223a, or controls the entirety of the molding apparatus 100 to perform an operation to open/close the first mold 210 and the second mold 220, or the like. Note that the first mold 210 driven by the control driving device 300 can move in a horizontal AB direction, and can also move in a vertical CD direction, as illustrated in FIG. 1. In addition, the second mold 220 driven by the control driving device 300 can move in the vertical CD direction. For example, when a mold closing operation is simultaneously performed on both molds 210 and 220, first, the first mold 210 is moved to a position below the second mold 220 in such a way that axes CX1 and CX2 of both molds 210 and 220 match each other, and consequently, the second optical transfer surface 221b on an upper side faces the first optical transfer surface 211b on a lower side. The second mold 220 is lowered, and is pressed toward the first mold 210 at a predetermined force.

As illustrated in FIG. 2, the glass drop forming device 400 includes a raw material supply part 410 and a dropping nozzle 420. The raw material supply part 410 and the dropping nozzle 420 are heated by a not-illustrated heater so that glass inside the raw material supply part 410 enters into a melting state, and glass that passes through the dropping nozzle 420 maintains the melting state. In the raw material supply part 410, movement or a timing of dropping molten glass is controlled by the control driving device 300.

The raw material supply part 410 accumulates molten glass G that has been melted by a not-illustrated melting pot or the like, and the raw material supply part 410 drops the molten glass G from the dropping nozzle 420 at a predetermined timing. It is desirable that the molten glass G before dropping maintain a uniform temperature state.

The dropping nozzle 420 is used to form a glass drop having a liquid drop state (or a molten glass drop) GD from the molten glass G supplied from the raw material supply part 410, and the dropping nozzle 420 drops the molten glass G by using the surface tension of glass itself. The dropping nozzle 420 is formed by a single member. By doing this, the dropping nozzle 420 can be easily manufactured, and the shape accuracy of the nozzle can be stabilized. The dropping nozzle 420 is formed, for example, of platinum, platinum alloy, or the like.

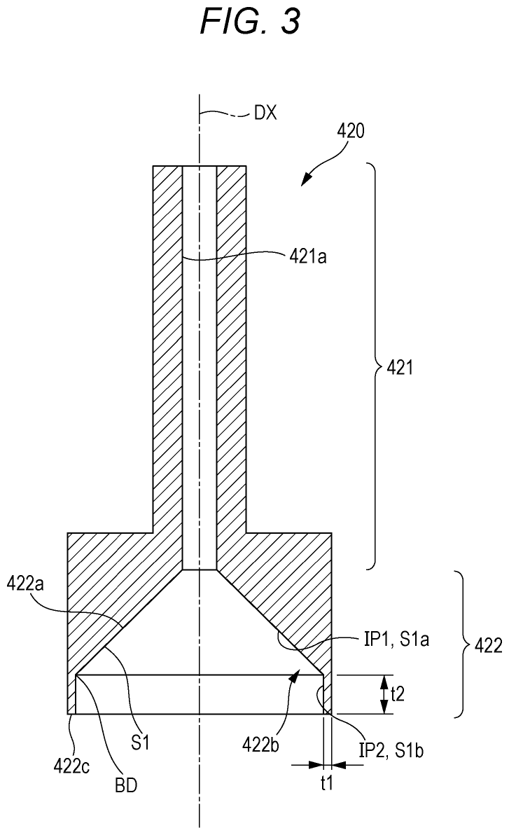

As illustrated in the enlarged view of FIG. 3, the dropping nozzle 420 includes a flow passage part 421 and an opening part 422. The dropping nozzle 420 has an external shape obtained by connecting two cylinders having diameters different from each other. The dropping nozzle 420 has an internal shape that is nearly rotationally symmetric with respect to a center axis DX of the flow passage part 421.

In the dropping nozzle 420, the flow passage part 421 principally includes a cylinder that is thinner and longer than the opening part 422, and one end of the flow passage part 421 communicates with the raw material supply part 410. In addition, the flow passage part 421 is also formed in part of a thick and short cylinder, and the other end of the flow passage part 421 communicates with the opening part 422. The flow passage part 421 includes a flow passage 421a that molten glass G passes through.

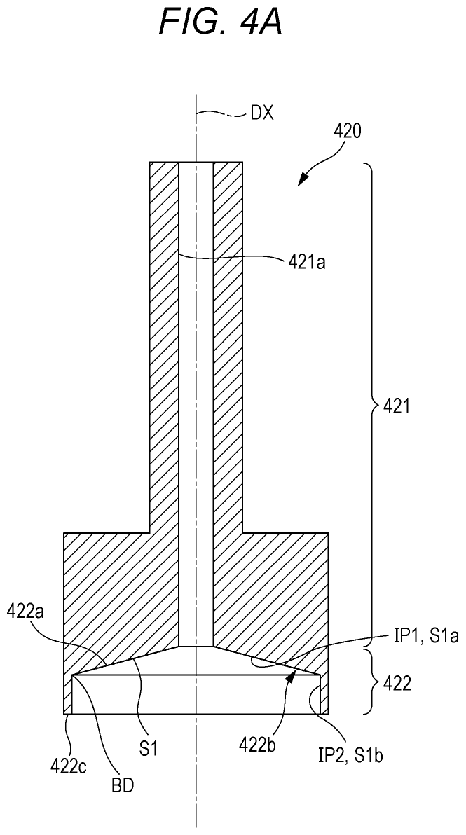

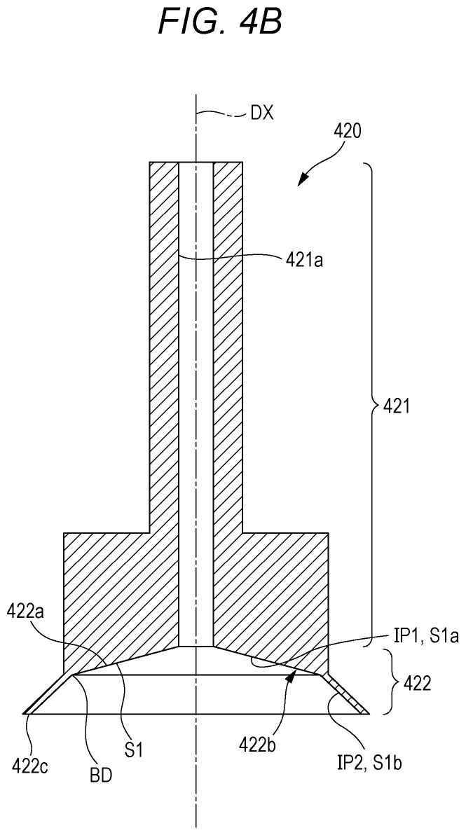

The opening part 422 includes a thick and short cylinder. One end of the opening part 422 communicates with the flow passage part 421, and the other end is open to the outside. The opening part 422 includes an opening 422a that communicates with the flow passage 421a, and the opening part 422 drops molten glass G as a glass drop GD. The opening 422a includes a plurality of inclined parts 422b in which adjacent inner inclination angles are different from each other in a section parallel to the center axis DX of the flow passage part 421. In the opening part 422, a first inclined part IP1 that is closest to the flow passage part 421 or the center axis DX from among the plurality of inclined parts 422b has an inner inclination angle that is smaller than an inner inclination angle of a second inclined part IP2 that is farthest from the flow passage part 421 or the center axis DX. Here, the inclination angle uses, as a reference, a plane that is perpendicular to the center axis DX of the flow passage part 421. In addition, in the inclined parts 422b, a part in which an inner inclination angle is switched is a boundary BD between the respective inclined parts IP1 and IP2. An inner diameter of the opening 422a is an expanded diameter that expands in a direction from a side of the flow passage 421a to a lowermost part 422c. It is desirable that the inclination angle of the first inclined part IP1 range, for example, from about 15° to about 45° in order to spread molten glass G in a radius direction or an outward direction of the nozzle. It is also desirable that the inclination angle of the second inclined part IP2 range, for example, from about 45° to about 90° in order to avoid the occurrence of wetting-up of glass (a phenomenon in which molten glass rises along a side surface of the nozzle). The inclined parts 422b according to the present embodiment are formed by two inclined parts IP1 and IP2. First and second inclined parts IP1 and IP2 adjacent to each other have inclination angles different from each other. In the example of FIG. 3, the inclination angle of the first inclined part IP1 is 45°, and the inclination angle of the second inclined part IP2 is 900. In the example of FIG. 4A, the inclination angle of the first inclined part IP1 from among the inclined parts 422b is 15°, and the inclination angle of the second inclined part IP2 is 90°. In the example of FIG. 4B, the inclination angle of the first inclined part IP1 from among the inclined parts 422b is 15°, and the inclination angle of the second inclined part IP2 is 45°.

In the dropping nozzle 420, a thickness t1 of the second inclined part IP2 is 0.1 mm or more and 1 mm or less, and it is preferable that the thickness t1 be less than or equal to 0.25 mm. By reducing the thickness t1 of the second inclined part IP2, as described as the range described above, the molten glass G is easily accumulated in the lowermost part 422c of the dropping nozzle 420. Therefore, wetting-up of glass is further avoided, and a variation in weight of the glass drop GD can be further reduced. By setting the thickness t1 of the second inclined part IP2 to be greater than or equal to 0.1 mm, easy manufacture can be achieved. In addition, by setting the thickness t1 of the second inclined part IP2 to be less than or equal to 1 mm, wetting-up can be further avoided.

Inner surfaces S1 of the inclined parts 422b include a plurality of flat surfaces. This enables the inclined parts 422b to be simply designed and manufactured. Here, the flat surface is a straight surface in a sectional view, and includes a conical surface, a cylindrical surface, and the like. In the present embodiment, the inner surfaces S1 of the inclined parts 422b include a first inner surface S1a that corresponds to the first inclined part IP1 and a second inner surface S1b that corresponds to the second inclined part IP2.

A length t2 of the second inclined part IP2 is greater than or equal to 2 mm. By doing this, the molten glass G is easily accumulated in the lowermost part 422c of the dropping nozzle 420. Therefore, wetting-up of glass is further avoided, and a variation in weight of the glass drop GD can be further reduced.

In the inclined parts 422b, the surface roughness of an inner surface S1 may be changed in each of the inclined parts IP1 and IP2. When the surface roughness of a surface S1 that is closer to the lowermost part 422c is reduced, a variation in weight of the glass drop GD can be reduced. For example, it is desirable that the surface roughness of the first inner surface S1a of the first inclined part IP1 be set to be greater than or equal to an arithmetic average roughness (Ra) of 6 nm that causes glass to easily get wet, and the surface roughness of the second inner surface S1b of the second inclined part IP2 be set to be less than or equal to an Ra of 6 nm that causes a reduction in a residue of dropping at the time of glass dropping.

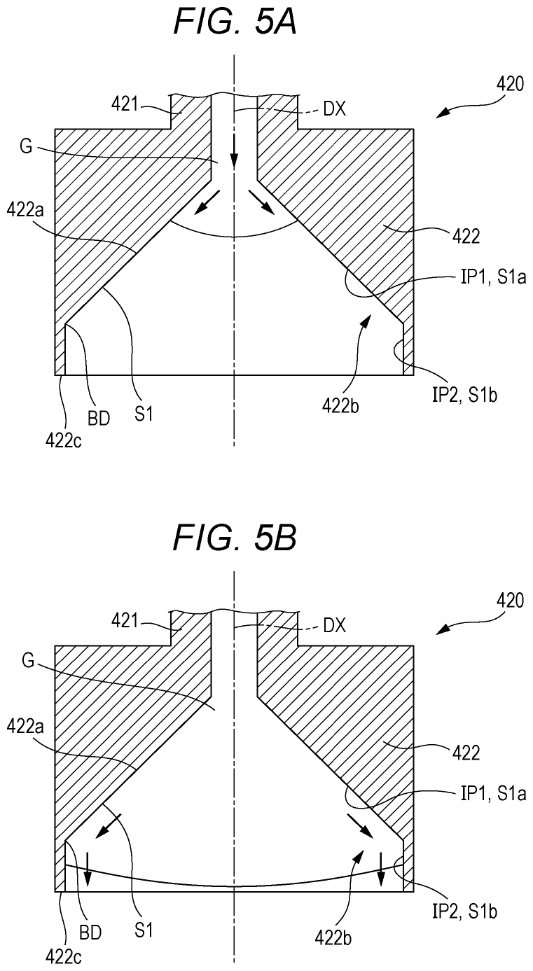

A flow of molten glass G inside the dropping nozzle 420 is described below. As illustrated in FIG. 5A, in the opening part 422, molten glass G that has flowed out from the flow passage part 421 flows in a spreading direction in the first inclined part IP1 having an inclination angle that is smaller than an inclination angle of the second inclined part IP2 from among the inclined pans 422b. Then, as illustrated in FIG. 5B, an inclination angle is switched at the boundary BD between the first inclined part IP1 and the second inclined part IP2, and therefore a flow of the molten glass G changes in a desired direction (in the illustrated example, in a nearly vertical direction). The inclination angle of the second inclined part IP2 that is closer to the lowermost part 422c has been set in such a way that the flow of the molten glass G is switched in a direction that avoids the wetting-up of glass. It is preferable that the inclination angles of the inclined parts 422b change in such a way that an inclined part 422b that is closer to the lowermost part 422c has an angle nearer to a right angle. The molten glass G that has flowed from the opening part 422 to the outside drops as a glass drop GD having a desired weight without passage through the lowermost part 422c and wetting-up on a surface outside the nozzle.

A method for manufacturing the lens 500 serving as a molded body by using the molding apparatus 100 illustrated in FIG. 1 and the like is described below with reference to FIGS. 6A to 6D.

First, as illustrated in FIG. 6A, the first mold 210 is disposed below the dropping nozzle 420 in such a way that a center (specifically, an axis CX1) of the first transfer surface 211a of the first mold 210 matches the center axis DX of the dropping nozzle 420 of the glass drop forming device 400. A glass drop GD that has dropped from the dropping nozzle 420 is caused to naturally drop from the opening part 422 of the dropping nozzle 420 onto the first transfer surface 211a. Prior to the dropping of the glass drop GD, the first transfer surface 211a has been heated by the electric heater 213a so as to have a temperature that is nearly equal to a glass transition temperature of molten glass G for an optical element that serves as a raw material of the lens 500. The glass drop GD has a desired weight that is nearly equal to the volume of the lens 500 as a whole. Here, as glass of a raw material to be used for the molten glass G, phosphate-based glass or the like is used, for example. After the dropping of the glass drop GD, the first mold 210 is caused to retreat from the glass drop forming device 400, and is moved to a position below the second mold 220.

As illustrated in FIG. 6B, after dropping, the glass drop GD flows and spreads on the first transfer surface 211a, and the first optical transfer surface 211b and the first flange transfer surface 211c are filled with the glass drop GD. Then, as illustrated in FIG. 6C, before the glass drop GD is completely solidified and while the glass drop GD has a temperature that enables the glass drop GD to be pressed and transformed, the second mold 220 is relatively pressed against the glass drop GD on the first mold 210, and molding is performed. At this time, the first mold 210 is moved to a position below the second mold 220 in such a way that the axes CX1 and CX2 of both molds 210 and 220 match each other. Consequently, pressing is performed in a state where the second optical transfer surface 221b on an upper side faces the first optical transfer surface 211b on a lower side. Note that the second mold 220 has been heated to have a temperature that is almost equal to a temperature of the first mold 210.

Next, according to a gradual decrease in the temperature of the glass drop GD, the lens 500 is molded that includes the first and second optical surfaces 511a and 521a and the first and second flange surfaces 511b and 521b (see FIGS. 6C and 6D). After the lens 500 has been sufficiently cooled down, the pressurization of the first mold 210 and the second mold 220 is released, and the second mold 220 is raised. Therefore, the lens 500 is released from the molds, and is taken out to the outside of the molds. After the lens 500 has been taken out, a flange 510b outside the lens 500 may be cut out by using a dicer or the like, and the shape of the lens 500 may be arranged.

The lens 500 illustrated in FIG. 6D has a circular external shape. The lens 500 includes a lens body 510a and the flange 510b that is formed around the lens body 510a. The lens body 510a includes the first optical surface 511a that is aspherical and has a convex shape on an object side, and the second optical surface 521a that is aspherical and has a convex shape on an image side. The flange 510b includes the first flange surface 511b that is flat and spreads around the first optical surface 511a, and the second flange surface 521b that is flat and spreads around the second optical surface 521a. The first and second flange surfaces 511b and 521b are disposed in parallel to an XY plane that is perpendicular to an optical axis OA. The external shape of the lens 500 is not limited to a circular shape, and may be an arbitrary shape such as a rectangular shape.

By employing the dropping nozzle 420 and the molding apparatus 100 including the dropping nozzle 420 that have been described above, in the first inclined part IP1, glass flows in an outward direction of the dropping nozzle 420 so as to spread, and the second inclined part IP2 has an appropriate inclination angle so as to rise, by setting an inclination angle of the second inclined part IP2 to be greater than an inclination angle of the first inclined part IP1. Therefore, a flow of glass is switched in such a way that wetting-up of the glass is avoided. By doing this, the weight of a glass drop GD is stabilized, and a lens 500 serving as a molded body that is excellent in accuracy can be obtained.

### Examples

Examples of the dropping nozzle according to the embodiment are described below. As a glass material, phosphoric acid-based glass (glass transition temperature Tg: 480° C.; aid specific gravity: 3.2) was used. This glass material was melted, and a glass drop was dropped by using a dropping nozzle that was heated to 1000° C. The sizes and shapes of dropping nozzles used in examples and a comparative example are indicated in Table 1 described below. In Table 1, the diameter of a nozzle is the diameter of an opening at an endmost part of a dropping nozzle. Nozzle 1 and Nozzle 2 are examples, and have a configuration in which an opening part includes two inclined parts (a configuration having two-stage inclination angles). Nozzle 3 is a comparative example, and has a configuration in which an opening part includes one inclined part (a configuration having a single inclination angle).

TABLE 1

| | | Inclination | Inclination | Thick- |
|---|---|---|---|---|
| | Diameter | angle | angle | ness |
| | ϕ (mm) | (°) of first | (°) of second | (mm) of |
| Dropping nozzle | of nozzle | inclined part | inclined part | nozzle |
| Nozzle 1 (Example 1) | 8 | 15 | 90 | 0.5 |
| Nozzle 2 (Example 2) | 8 | 15 | 90 | 0.25 |
| Nozzle 3 (Comparative | 8 | 90 | — | 0.5 |
| Example) | | | | |

Table 2 indicates the dropping weight of a glass drop and a variation in the dropping weight in Example 1 in which an opening part has a plurality of inclination angles and Comparative Example in winch an opening part has a single inclination angle.

TABLE 2

| | Weight (mg) of glass drop | |
|---|---|---|
| | | Nozzle 3 |
| Number of times | Nozzle 1 | (Comparative |
| of measurement | (Example 1) | Example) |
| 1 | 389.5 | 389.6 |
| 2 | 389.8 | 390.0 |
| 3 | 389.9 | 389.2 |
| 4 | 389.4 | 390.4 |
| 5 | 389.6 | 389.6 |
| Mean. | 389.6 | 389.8 |
| Standard deviation σ | 0.21 | 0.46 |

As indicated in Table 2, in a dropping nozzle having two inclination angles, a variation in weight of a glass drop was σ 0.21 mg. In contrast, in a dropping nozzle having a single inclination angle, a variation in weight of a glass drop was σ 0.46 mg. It is apparent from the above that, in a dropping nozzle in which an opening part has a plurality of inclination angles, a variation in weight of a glass drop can be reduced.

Table 3 indicates the dropping weight of a glass drop and a variation in the dropping weight in Example 1 and Example 2. Example 1 is different from Example 2 in the thickness of a second-stage inclined part (an inclined part that is farthest from a flow passage part).

TABLE 3

| Number of times | Weight (mg) of glass drop | |
|---|---|---|
| of measurement | Nozzle 1 (Example 1) | Nozzle 2 (Example 2) |
| l | 389.5 | 390.5 |
| 2 | 389.8 | 390.4 |
| 3 | 389.9 | 390.2 |
| 4 | 389.4 | 390.3 |
| 5 | 389.6 | 390.4 |
| Mean | 389.6 | 390.4 |
| Standard deviation σ | 0.21 | 0.11 |

As indicated in Table 3, it is apparent that a variation in weight of a glass drop can be further reduced in the dropping nozzle of Example 2 that includes a thin second-stage inclined part, in comparison with the dropping nozzle of Example 1. As described above, as an inclined part that is farthest from a flow passage part becomes thinner, the dropping weight of a glass drop becomes stabber. However, when the inclined part is excessively thin, the strength of a nozzle is reduced, and therefore a thickness that is sufficient to maintain durability is required.

### Second Embodiment

A dropping nozzle according to a second embodiment of the present invention is described below. The dropping nozzle according to the second embodiment is obtained by transforming the dropping nozzle according to the first embodiment, and matters that are not described otherwise are similar to matters in the first embodiment.

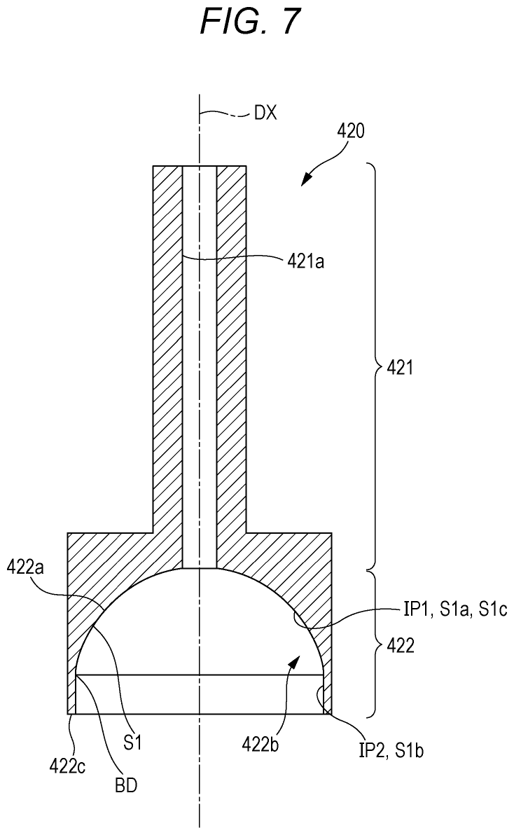

As illustrated in FIG. 7, at least some of inner surfaces S1 of inclined parts 422b include a curved surface S1c (a surface having a continuously variable angle, such as a circular arc). In the present embodiment, the inner surfaces S1 of the inclined parts 422b include a first inner surface S1a that corresponds to a first inclined part IP and a second inner surface S1b that corresponds to a second inclined part IP2, and the first inner surface S1a includes the curved surface S1c. Here, an inclination angle of the first inclined part IP1 has been set to an angle obtained by averaging or approximating the curved surface S1c having, for example, a circular arc shape, under the assumption of a straight line. From among the inclined parts 422b, the first inclined part IP1 may be a curved surface, or another inclined part may be a curved surface. In addition, in the first inclined part IP1, the curved surface may warp in an outward direction or may warp in an inward direction.

In the dropping nozzle according to the present embodiment, at least some of the inner surfaces S1 of the inclined parts 422b include the curved surface S1c, and therefore a flow of molten glass can be easily adjusted.

### Third Embodiment

A dropping nozzle according to a third embodiment of the present invention is described below. The dropping nozzle according to the third embodiment is obtained by transforming the dropping nozzle according to the first embodiment, and matters that are not described otherwise are similar to matters in the first embodiment.

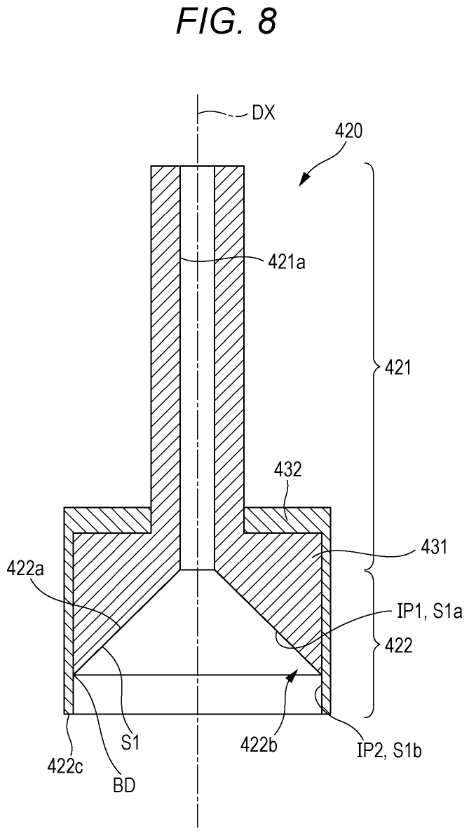

As illustrated in FIG. 8, a dropping nozzle 420 includes a plurality of members. In the present embodiment, in the dropping nozzle 420, a first inclined part IP1 is formed by a first member 431 integrated with a flow passage part 421. A second inclined part IP2 is formed by a second member 432 that is formed separately from the first member 431. The second member 432 is a cylindrical or cap-shaped member. The second member 432 is fitted so as to surround the first member 431, so that the dropping nozzle 420 can be assembled.

In the dropping nozzle according to the present embodiment, by changing members that form the inclined parts 422b, the angles and lengths of the inclined parts 422b can be easily changed.

The dropping nozzle and the like according to the present embodiment have been described above. However, a dropping nozzle and the like according to the present invention are not limited to the above. For example, in the embodiments described above, the inclination angles of the inclined parts 422b of the dropping nozzle 420 can be appropriately changed. In addition, three or more inclination angles can form the inclined parts 422b. Further, the inclined parts 422b can have a configuration having a stepwise shape that spreads downward.

In addition, in the embodiments described above, the shapes of the first and second transfer surfaces 211a and 221a of the mold 200 can be appropriately changed according to the shape of a molded body to be molded. For example, the first and second transfer surfaces 2111a and 221a are not limited to transfer surfaces that mold a single lens, and may be transfer surfaces that mold a lens array including a plurality of lens.

Further, in the embodiments described above, the external shape of the dropping nozzle 420 can be appropriately changed. Furthermore, the sectional shapes, lengths, internal diameters, and the like of the flow passage 421a and the opening 422a can also be appropriately changed.

Although embodiments of the present invention have been described and illustrated in detail, the disclosed embodiments are made for purposes of illustration and example only and not limitation. The scope of the present invention should be interpreted by terms of the appended claims.

What is claimed is:

1. A dropping nozzle comprising:
a flow passage part that includes a flow passage that molten glass passes through; and
an opening part that includes an opening that communicates with the flow passage, the opening part dropping the molten glass as a glass drop, wherein
the opening includes a plurality of inclined parts in which adjacent inner inclination angles are different from each other in a section parallel to a center axis of the flow passage part, and
from among the plurality of inclined parts, a first inclined part that is closest to the flow passage part has an inner inclination angle that is smaller than an inner inclination angle of a second inclined part that is farthest from the flow passage part.

2. The dropping nozzle according to claim 1, wherein
a thickness of the second inclined part is 0.1 mm or more and 1 mm or less.

3. The dropping nozzle according to claim 1, wherein
inner surfaces of the plurality of inclined parts include a plurality of flat surfaces.

4. The dropping nozzle according to claim 1, wherein
at least some of inner surfaces of the plurality of inclined parts include a curved surface.

5. The dropping nozzle according to claim 1, wherein
a length of the second inclined part is greater than or equal to 2 mm.

6. The dropping nozzle according to claim 1, wherein
the dropping nozzle includes a single member.

7. The dropping nozzle according to claim 1, wherein
the dropping nozzle includes a plurality of members.

8. A molding apparatus comprising:
the dropping nozzle according to claim 1;
a raw material supply part that supplies the molten glass to the dropping nozzle; and
a mold that molds a glass molded body by using the glass drop that has been dropped from the dropping nozzle.
